(19) United States
(12) Patent Application Publication
(10) Pub. No.: US 2026/0281002 A1
(43) Pub. Date: Sep. 17, 2026

(54) OPERATION OF AGENTS IN A COMMUNICATION NETWORK

(71) Applicant: Telefonaktiebolaget LM Ericsson (publ), Stockholm (SE)

(72) Inventors: Maxime BOUTON, Stockholm (SE); Alexandros PALAIOS, Herzogenrath (DE); Philipp GEUER, Frechen (DE); Cara WATERMANN, Dusseldorf (DE); Jaeseong JEONG, Solna (SE); Konstantinos VANDIKAS, Solna (SE)

(21) Appl. No.: 19/161,937

(22) PCT Filed: Sep. 15, 2023
(86) PCT No.: PCT/EP2023/075476

§ 371 Date: Sep. 3, 2025

(30) Foreign Application Priority Data
Mar. 3, 2023 (GR) 20230100182

(51) Int. Cl. H04L 41/16; H04L 41/046; H04L 41/0894; H04L 41/0895; H04L 41/14

(52) U.S. Cl. CPC H04L 41/16; H04L 41/046; H04L 41/0894; H04L 41/0895; H04L 41/145

(57) ABSTRACT

According to an aspect, there is provided a computer-implemented method of managing operations of a plurality of agents. Each agent is for adjusting values of one or more parameters in a respective network part of the communication network. The method comprises obtaining configuration information for the plurality of network parts; for each part of the plurality of network parts, determining a respective exploration policy to be used by an agent to determine adjustments to the values of the one or more parameters in the respective network part, wherein the exploration policy is determined based on the received configuration information for the plurality of network parts; and deploying the respective determined exploration policy or an exploratory action determined from the respective determined exploration policy to the respective network part.

### TECHNICAL FIELD

This disclosure relates to the use of agents in a communication network, and in particular to agents, for example reinforcement learning (RL) agents, that are to adjust values of one or more parameters in parts of the communication network.

### BACKGROUND

Deploying autonomous decision making agents in a communication network has a lot of potential for both reducing operation costs and improving the network performance. In the case where the decisions to take are complex and depend on a lot of variables in the network, it can be useful to represent those agents by machine learning (ML) systems which dynamically update their decision strategy using data collected during deployment.

One example is to use reinforcement learning for network design and optimisation. Several base station parameters such as downlink power are remotely controllable, and products are being developed to control these parameters using artificial intelligence (AI) agents. One such product are the Ericsson Performance Optimizers (https://www.ericsson.com/en/managed-services/cognitive-technology). Current products rely on simulated data or an existing dataset to learn their decision strategies. However, it is expected that those agents could gain a lot of performance if they were able to automatically explore the live network to discover parameter settings that would yield even more performance improvements. However, allowing the machine learning models to explore the network could also yield great degradations in operational performance and is associated to a risk that must be mitigated.

### SUMMARY

The solution published in WO 2022/023218 exploits live exploration in the network by using a safety shield. This document proposes a method for Safe Reinforcement Learning (SRL) that changes the standard RL interaction cycle so as to ensure the safety of the environment with respect to performance of a task. The method may be envisaged as implementing a safety shield which protects an environment by preventing a Learning agent from interacting directly with the environment, and safety logic which determines what action should be provided by the shield to the environment for execution.

In the case of exploration by a single agent, a safe Bayesian optimisation process (e.g. as described in “Bayesian Optimization with Safety Constraints: Safe and Automatic Parameter Tuning in Robotics” by Felix Berkenkamp et al.) can be used to balance safety, exploration and exploitation.

Typically, exploration can be carried out jointly by many agents deployed in the networks. When autonomous agents are deployed to control a base station parameter, they are expected to be deployed in many cells in the network and can share the learning from one deployment to another.

The techniques described herein thus extends the above concepts to multiple agents solving the same safe Bayesian optimisation problem at the same time, thus benefiting from each other's experience.

Experience sharing and model sharing is generally useful to increase sample efficiency. Existing processes leveraging multi-agent formulation focus on experience sharing (e.g. as described in “Shared Experience Actor-Critic for Multi-Agent Reinforcement Learning” by Filippos Christianos et al.) in order to improve the overall performance, but they do not introduce any way to coordinate the exploration of the agents.

The techniques described herein also rely on experience and model sharing, but introduce a safety dimension and a joint exploration objective to best balance the exploration risk in the whole network.

In particular, this disclosure proposes a solution to manage which agents can be allowed to perform exploratory actions in the network, and what degree of exploration is allowed. A method is proposed that takes advantage of the fact that multiple agents can be deployed at the same time, optimising the same parameter at different places in the network. This similarity in the deployment can allow certain agents to perform exploration in order to improve the performance of other agents. This solution offers a flexible and principled way to manage the exploration across low risk agents, while improving the performance of all, or a selected few, agents in the network.

Thus, the proposed solution introduces an exploration management function which can be configured by a node in the communication network, a network operator or a network function (NF) to identify which cells or parts of the network are business critical or can be used for exploration. The exploration management function can also or alternatively compute, in a principled way, which exploration policy each agent in the network should follow.

The exploration management function can use machine learning models (MLMs) representing the expected performance of each agent, and their safety level. It can use those models to appropriately select exploration policies in a coordinated way for all agents in the network to respect the specified risks from the operator.

The proposed solution provides an efficient way for a network operator to manage the risk caused by deploying autonomous agents over part or the whole network. It is possible to automatically and dynamically manage which parts of the network in which exploration should be performed or not. In this way, self-improving operation of the communication network may be achieved while minimising degradation of operational performance.

In addition, data from the explored network parts (e.g. cells) can be reused to improve performance in the non-explored parts (cells) with high business value. If data sharing across parts of the network provides a privacy concern, the operator can have the possibility to specify which part/cell can share data with each other, or use mechanisms that allow the data to be securely combined without the exploration management function or a model training function being able to ascertain which agent(s) provided the data. This can allow the improvement of the performance of agents in critical parts of the network by doing exploration in other parts; the measurable effect being that agents in critical parts have better performance with no added exploration risk, which provides for self-improving operation of the communication network where degradation to critical services and operation is minimised, while at the same time exploiting less mission-critical parts of the network for more risky learning activities.

According to a first aspect, there is provided a computer-implemented method of managing operations of a plurality of agents. Each agent is for adjusting values of one or more parameters in a respective network part of the communication network. The method comprises obtaining configuration information for the plurality of network parts; for each part of the plurality of network parts, determining a respective exploration policy to be used by an agent to determine adjustments to the values of the one or more parameters in the respective network part, wherein the exploration policy is determined based on the received configuration information for the plurality of network parts; and deploying the respective determined exploration policy or an exploratory action determined from the respective determined exploration policy to the respective network part.

According to a second aspect, there is provided a computer program comprising computer readable code configured such that, on execution by a suitable computer or processor, the computer or processor is caused to perform the method according to the first aspect or any embodiment thereof.

According to a third aspect, there is provided an exploration management function for managing operations of a plurality of agents. Each agent is for adjusting values of one or more parameters in a respective network part of the communication network. The exploration management function is configured to obtain configuration information for the plurality of network parts; for each part of the plurality of network parts, determine a respective exploration policy to be used by an agent to determine adjustments to the values of the one or more parameters in the respective network part, wherein the exploration policy is determined based on the received configuration information for the plurality of network parts; and deploy the respective determined exploration policy or an exploratory action determined from the respective determined exploration policy to the respective network part.

According to a fourth aspect, there is provided an exploration management function comprising a processor and a memory. The exploration management function is for managing operations of a plurality of agents. Each agent is for adjusting values of one or more parameters in a respective network part of the communication network. The memory contains instructions executable by said processor whereby said exploration management function is operative to obtain configuration information for the plurality of network parts; for each part of the plurality of network parts, determine a respective exploration policy to be used by an agent to determine adjustments to the values of the one or more parameters in the respective network part, wherein the exploration policy is determined based on the received configuration information for the plurality of network parts; and deploy the respective determined exploration policy or an exploratory action determined from the respective determined exploration policy to the respective network part.

### BRIEF DESCRIPTION OF THE DRAWINGS

Some of the embodiments contemplated herein will now be described more fully with reference to the accompanying drawings, in which:

FIG. 1 illustrates an exemplary implementation of a network performance improvement system according to the techniques described herein;

FIG. 2 illustrates a cell configuration use case;

FIG. 3 shows a set of graphs showing exemplary performance and safety levels for different cells;

FIG. 4 is an illustration of a pure exploration policy with safety constraints;

FIG. 5 is a signalling diagram illustrating use of an exploration management function in a 3GPP network;

FIG. 6 is a signalling diagram illustrating an exploration management function in an open-RAN implementation;

FIG. 7 is a flow chart illustrating a method of operating an exploration management function in accordance with some embodiments;

FIG. 8 is a block diagram of an exploration management function according to some embodiments; and

FIG. 9 is a block diagram illustrating a virtualization environment in which functions implemented by some embodiments may be virtualized.

### DETAILED DESCRIPTION

Some of the embodiments contemplated herein will now be described more fully with reference to the accompanying drawings. Embodiments are provided by way of example to convey the scope of the subject matter to those skilled in the art.

While the techniques described herein are generally applicable to any type of communication network, including telecommunication networks, computer networks, cloud computer networks, etc., the techniques are described with respect to a cellular communication network, i.e. a communication network that is logically divided into cells, where agents are deployed and used to perform exploration actions in the cells. As a particular example, the cellular communication network can be a network in accordance with one or more 3rd Generation Partnership Project (3GPP) specifications, such as a 4th Generation (4G)/Long Term Evolution (LTE) network or a 5th Generation (5G)/New Radio (NR) network. A cell can be any type of cell, e.g. a macro cell, a micro cell, a femto cell or a pico cell.

In the case of a computer network or a cloud (distributed) computer network, a network part can be a cluster of one or more computing devices (computers, servers, etc.). The computing devices in a cluster may be co-located (e.g. in the same premises), with different clusters being at different locations.

In general, “network parts” are parts of a communication network that share some similarity in characteristics and/or properties that enable learnings from agents deployed for respective network parts of the communication network to be shared and used to improve the operations of the agents, and thus improve the performance of the communication network.

In addition, while the techniques are described as relating to reinforcement learning (RL) agents, i.e. agents that use RL techniques, the techniques can be implemented using any type of autonomous decision-making agent. An alternative type of agent that can be used includes an agent that uses classical control theory (proportional control)

More specifically, an agent is an entity that receives observations from the network and responds with an action, such as adjusting/changing a value of a parameter, e.g. a network configuration parameter. Agents can typically rely on a value function. A value function is a machine learning (ML) model (MLM) giving an estimation of the performance of each action given the current observation. This value model can have uncertainty measures (e.g. Gaussian process). After adjusting the parameter value, the agent monitors the network part to measure or evaluate the effect of the parameter value change on the performance.

As used herein, an “exploratory action” is an action taken by the agent that is purposedly sub-optimal (i.e. a value of a network configuration parameter is selected that is not expected to provide the optimal performance. Instead of taking an action that would be optimal according to the agent's own value function, the agent will decide to take a sub-optimal action.

As used herein, an “exploration policy” is the process or rules used by an agent or other node to compute an exploratory action based on its own internal knowledge. An exploration policy generally indicates, or provides information indicating, an amount and/or range of exploratory actions that can be performed for a respective network part. Example of exploration policies include:
ϵ-greedy: where a random action is chosen with probability ϵ, and the optimal action is chosen with probability 1-ϵ. By tuning ϵ, the risk of this policy can be controlled;
Upper Confidence Bound (UCB): in the case where the agent knows the uncertainty around its value estimate, the agent can balance exploration and exploitation by picking actions with a high upper confidence bound.

When an agent is not ‘exploring’ (i.e. performing an exploratory action), the agent can use a greedy policy which has the lowest level of risk, and is equivalent to always taking an optimal action according to the agent's own value function.

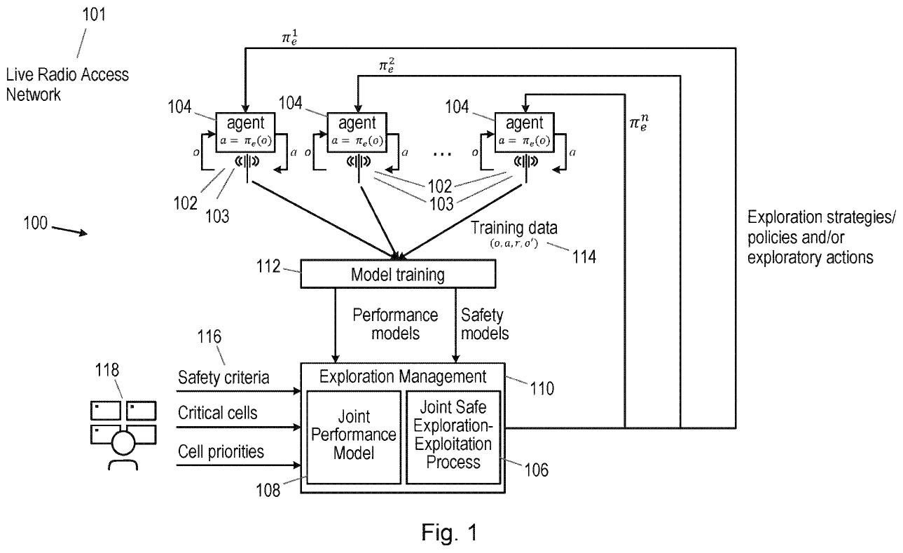

FIG. 1 illustrates an exemplary implementation of a network performance improvement system 100 according to the techniques described herein. The network performance improvement system 100 is being used to improve the performance of a cellular communication network, and in particular a radio access network (RAN) 101 that includes a plurality of RAN nodes 102, such as base stations, eNBs, gNBs, access points (APs), etc. Each RAN node 102 may be responsible for one or more cells (parts) 103 of the network 101. In this illustrated example, it is assumed that each RAN node 102 has a single cell 103.

The network performance improvement system 100 comprises a plurality of agents 104 that are deployed in the RAN 101. Each agent 104 is for adjusting one or more parameters in a respective cell 103.

The network performance improvement system 100 also comprises an exploration management function 106 that is responsible for determining exploration policies, and deploying these (or exploratory actions resulting therefrom) into the cells 103. In particular embodiments, the exploration management function 106 executes or uses a joint performance model 108 that is used to compute the joint performance of parts (cells 103) of the RAN 101 to optimise. In some embodiments, the exploration management function 106 can execute or use a joint safe exploration-exploitation process 110 for computing the exploration policies for each cell 103.

A model training function 112 is also provided that is responsible for training the model or models 108, 110 used by the exploration management function 106 to determine the exploration policies. The training by the model training function 112 is based on observations/measurements of the performance of the cells 103 received from the agents 104. These observations/measurements are also referred to as ‘training data’ 114. The model training function 112 also trains/retrains the agents 104 using data/measurements of the network collected by the agents 104.

The exploration management function 106 receives or obtains configuration information 116 for the cells 103 and uses this configuration information 116 to determine the exploration policies. The configuration information 116 may be input to the exploration management function 106 by an operator 118 of the communication network or RAN 101, or may be determined by one or more network functions (NFs).

More generally, the exploration management function 106 collects trained models 108, 110 representing the performance and the safety level of the agents 104. Using those models 108, 110, along with the operator specification (configuration information 116), the exploration management function 106 can use the joint safe exploration-exploitation process 110 to compute exploration policies for each agent 104. The goal of the process can be to both maximise the performance in a critical and prioritised cell 103, as well as reducing uncertainty in the models 108, 110.

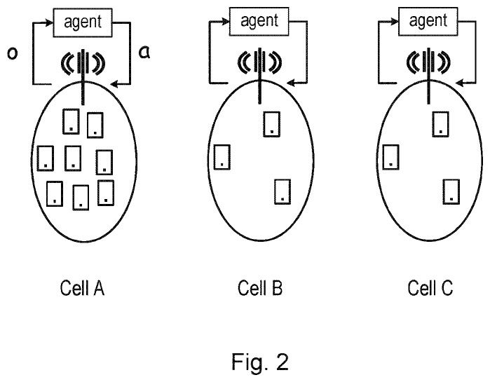

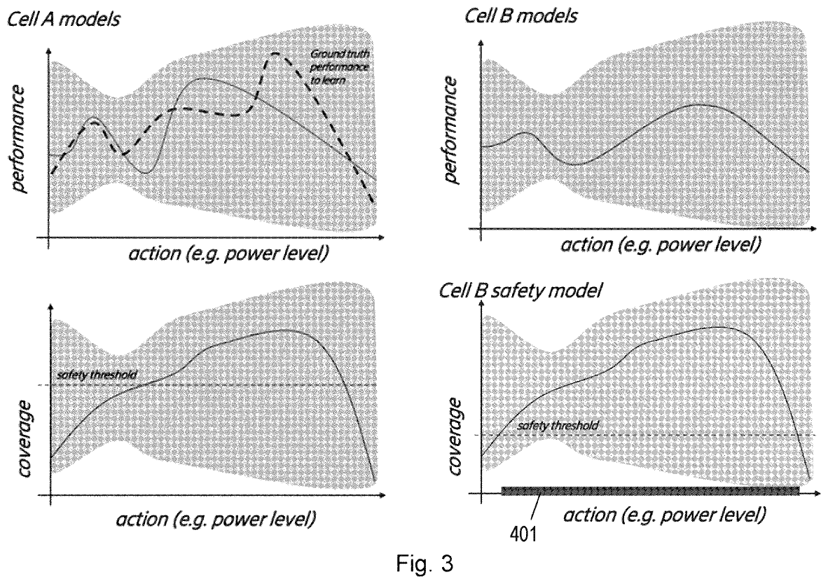

As an example of the use of the exploration management function 106, consider the use case of deploying agents in a live cellular network with multiple cells to control a parameter of the base stations such as downlink power, based on some observed key performance indicators (KPIs) such as coverage of the cell, quality of the signal for edge users, and capacity of the cell. Referring to FIG. 2, agents are deployed in multiple cells A, B, and C. These agents address the same network optimisation problem and share the same underlying state action value estimate.

Cell A has a lot of users (e.g. user equipments (UEs) requesting high quality of service, and so degrading the performance in this cell could have a strong negative impact on the business of the network operator, and it is safer to instruct the agent not to perform exploration and follow a greedy policy. In cells B and C there is much less traffic (due to fewer users in those cells) and potentially fewer demanding requests from the users, so it would be tolerable to perform exploratory actions in those cells.

The desired effect of the techniques described herein is that it will spread all the exploration risk towards specific cells such as cell B, and cell C. The agents 104 in cell B and cell C can perform exploration and send the collected data back to model training function 112. This new data will be used to retrain the models used by the agents 104. A new model can be deployed in cell A (and cell B and C) which will benefit from the improved performance. At any time, the agent 104 in cell A has not caused the cell to take any sub-optimal actions, and the agent 104 in cell A can continue to use its greedy policy, thus avoiding a trade off with exploitation gains.

At a high level, the techniques described herein can be considered to involve one or more of the following steps:
(i) a configuration step in which the exploration management function 106 obtains configuration information 116 for the network/cells;
(ii) an obtaining step in which the models to be used to generate the exploration policies are obtained;
(iii) a model computation step in which a joint performance model 108 is computed;
(iv) an exploration policy computation step in which a safe exploration-exploitation process 110 is used to determine exploration policies for each cell;
(v) an exploration step in which the agents 104 follow the determined exploration policies; and
(vi) an updating step in which the joint performance model 108 and/or safe exploration-exploitation process 110 are updated based on the observations/measurements of the cell/network by the agents 104.

These exemplary steps are described in more detail below.

Step (i)—The exploration management function 106 requires some specific configuration information 116 from the network operator. This configuration information 116 can relate to the network as a whole and/or to parts of the network, such as respective cells. The configuration information 116 may be determined dynamically by the network operator or a NF, and/or part or all of the configuration information 116 can be static (i.e. predetermined). In general, the configuration information provides an indication of (or can be used to determine) the type and/or extent of exploratory actions that can be permitted or performed for a particular network part (cell). Different types of configuration information 116 can be considered:
Safety criteria: the operator can specify safety criteria for each cell, and the safety criteria can indicate which cell(s) can be dynamically explored or not. Safety can be defined in a number of different ways, and include, for example, an allowed KPI(s) range, such as allowed coverage or throughput degradation, allowed delay, etc. In case some cells (e.g. cells at the edge of the network) are known to be risk free (or low risk), they can be labelled (by the network operator and/or the exploration management function 106) as ‘exploratory cells’, meaning that all exploratory actions are allowed in these cells. Similarly, cells can be labelled as ‘critical cells’, meaning that exploratory actions are never allowed.
Time-aware safety criteria: in addition to providing safety criteria as outlined above, certain time windows may be defined for those criteria. For example, there may be hard safety constraints in some cell in a given time window, which is an indication that the exploration management function 106 is to not schedule exploration campaigns during those specific times.
Joint performance measurement method: the exploration management function 106 can attempt to start exploration in order to maximise a joint performance metric. This performance metric can be an aggregate of the performance of multiple cells. This aggregate can be weighted by weights specified by the operator, the aggregate can be an average or a weighted average, or otherwise be derived from the provided configuration information. An alternative approach is for only a few cells to be labelled or selected as ‘business critical’. The exploration management function 106 will determine exploration policies to guide exploration to try to improve the performance of these business critical cells first.
Cell criticality level: As an example, cells can be labelled as business critical (as noted above), exploratory (e.g. allowing all exploratory actions) or neutral (balanced exploration). A finer granularity of levels could alternatively be used. The cell criticality level can alternatively be provided as one of ‘high’ and ‘low’, or one of ‘high’, ‘medium’ and ‘low’. The cell criticality level can relate to the volume of traffic in the cell. The cell criticality level can be used by the agent 104 when scheduling exploration or by the exploration management function 106 when determining the exploration policies.
A privacy criteria: this can be specified for each cell that indicates whether the cell can share their data or model with the other cells involved in the exploratory actions. This privacy criteria is discussed further below.
Cell priority: for each criticality level, a priority or priority function (that would update the priorities) can be provided to the exploration management function 106.

In an example relating to the network shown in FIG. 2, a coverage degradation threshold is set for all the cells, with a higher threshold for cell A than for cells B and C. The joint performance measurement is set to match cell A's performance. Cell A is labelled as critical, while cell B is labelled as exploratory, and cell C is labelled as neutral.

Step (ii)—Obtaining the models. The exploration management function 106 can request the model training function 112 provide the trained models 108, 110. The models might have different requirements on KPIs in terms of safety though. Two types of model can be considered:
A performance model denoted Q(o, a) where o represents the observed KPIs by the agent 104 (such as coverage and capacity), and a represents the exploratory actions the agent 104 can take (such as changes in downlink power). The performance model can be the same for each cell, or there can be different variations of the performance model depending on how each cell prioritises the optimisation objectives. For example, some cells might prioritise capacity over coverage, or vice versa. There can be as many as one model per cell, and as little as one shared model.
A safety model which indicates a degree of safety satisfaction, denoted S(o, a). The definition of the safety model depends on which KPIs and acceptable range are specified in the configuration information 116. There can be one safety model per specified KPI(s). For example, there can be one safety model related to coverage, one safety level related to signal quality, and so on. The exploration management function 106 can use these safety model(s) to compute satisfiable exploration ranges for each cell in a later step.

All the models can be associated with uncertainty bounds for devising a more efficient exploration strategy. σ_{Q}(o, a), and σ_{S}(o, a) can be defined as the uncertainty associated to satisfying a given KPI range. In the following, the models are noted using one letter to represent both the mean estimate and the uncertainty bounds.

Each cell can have their own performance models Qᵢ and own safety models Sᵢ with associated uncertainty estimates. However they all share the same input space, and they use the same type of observations and actions.

FIG. 3 is a set of graphs showing exemplary performance and safety levels for cells A and B in FIG. 2. In particular, one pair of graphs plot the action (different power levels) against performance for Cell A and Cell B respectively. A second pair of graphs plot the action (different power levels) against coverage for Cell A and Cell B respectively. In the example of FIG. 3, the models are all observation dependent, but for ease of illustration, in FIG. 3 the models are represented as one-dimensional. It can be seen that Cell A and Cell B have different safety thresholds.

The shaded area in the plots represent the uncertainty bounds around the models.

Step (iii)—Computing a joint performance model 108. In particular, this step can comprise computing the joint performance to maximise. This joint performance can be a combination of the performance of multiple ‘business critical’ cells. In the simplest case, it can be the performance of the most critical cell Qᵢ. It could also be a sum of the performance of two critical cells Qᵢ+Qⱼ, or a product, or any other mathematical combination. The joint performance is denoted J(o, a). The joint performance is associated with an uncertainty measure that is computed using the knowledge of the individual performance model uncertainty, σ_{J}.

In an example, the network operator can specify that cell A of FIG. 2 is the only ‘business critical’ cell. In that case, J(o, a)=Q_{A}(o, a), and the same for the uncertainty. The Cell A action-performance plot (the top-left plot) in FIG. 3 is a graph showing an exemplary joint performance model, which in this case is equivalent to Q_{A} (other joint models such as Q_{A}+Q_{B} could be considered). In this example, all cells would perform exploratory actions to improve this model. This example would illustrate an extreme case where cell A is a particularly critical cell that operators want to prioritize against all other cells.

Step (iv)—In this step the exploration management function 106 uses the safe exploration-exploitation process 110 to compute exploration policies for each cell (agent 104). The process is initially described at a high level with respect to its input and outputs, and an example of the process is provided.

Inputs: the inputs to the safe exploration-exploitation process 110 can be the joint performance model 108 and its uncertainty estimate, the safety models for each individual cell and its performance estimate, and/or operator specifications on cell priorities and safety criteria (as described in with respect to step (i) above).

Output: the outputs of the safe exploration-exploitation process 110 can be an exploration policy for each cell. The exploration policy is a function (possibly stochastic) that takes as input an observation, and returns an action. This function has internal knowledge of the joint performance model 108 and the safety criteria 116. An example of how these functions can be designed is described below:

Inputs: J, Qᵢ Sᵢ, ∀ᵢ, critical cells, pure exploration cells, total allowed exploration cells, exploration time windows
For each critical cell i:
set exploration policy to greedy: π(o)=argmax Qᵢ(o,.)
   if the safety criteria allows for some exploration, use safe Bayesian optimisation instead.
   For each pure exploration cell (sorted by priority):
if total exploration allowed exploring cells exceeded: exit
set exploration policy to pure exploration using J as the source of uncertainty measurement. π(o)=argmax σ_{J}(o,.). Other strategies involve using pure random actions, or sampling actions at random if the associated uncertainty σ_{J}(o, a) is higher than some threshold
   For other cells (sorted by priority):
if total exploration allowed exploring cells exceeded: exit
set exploration policy to safe Bayesian optimisation with objective function/and safety Sᵢ

### Example Process for Designing Exploration Policies

The categorisation of the cells to different exploration levels (e.g. critical, pure exploration, balanced exploration) can align with the different types of cells present in the network. Considering a heterogeneous network:
Capacity cells: these cells can often be in sleep mode, but when they are used it means that there is a lot of traffic in the network and their status should be critical, so no exploration is permitted or performed in those cells.
Coverage cells: 4G cells or 5G macro cells, these cells typically cover users when the capacity cells are turned off. They generally have a lot of impact on the overall network performance, but when capacity cells are on, most of the traffic would go to capacity cells and balanced exploration can be performed in those macro cells (e.g. using safe Bayesian optimisation).
Resource pool cells: These cells are provided for redundancy and are only used when a boost in performance is needed. Most of the time pure exploration can be used in these cells.

In a ‘pure exploration’ approach, the agent always takes a sub-optimal action, with the goal being to reduce uncertainty about the underlying performance model, without trying to maximise the performance. In a ‘balanced exploration’ approach, there is a trade-off between reducing the uncertainty, being safe, and maximising performance. UCB and safe Bayesian optimisation are examples of a balanced approach.

The process 110 for computing the exploration policies can be configured in many ways. For example the level of exploration in the pure exploration cells can be further controlled. The exploration-exploitation trade-off when performing safe Bayesian optimisation can also be controlled for each cell.

In some cases, the generated exploration policies can be conditioned on time of the day if specified by the operator. For example, pure exploration can be set to start only at a specified time of the day, e.g. as described above with respect to the time-aware safety criteria.

When going through all the cells, the process 110 can first order them by priority. The priority can be specified by the operator in the configuration information 116. The priority can also be updated dynamically if a method is specified. An exemplary method for setting the priority of the cell dynamically is to use a similarity metric such that cells similar to the business critical cells are considered first. Similarity can be measured using the observed KPIs and characteristics about the traffic in the cells.

Time-based exploration: the process 110 can be extended to support time-based exploration. For each cell, the operator can specify time windows in which the exploration could be performed or not. When determining or selecting an exploration policy for a cell, the process 110 can make the exploration policy respect a given time window for exploration. For example, if the policy is pure exploration, the process can instruct the agent for the cell (or the exploration policy can contain instructions for the agent) to perform the policy only in the specified time windows, and optionally use a different exploration policy at other times (e.g. a greedy exploration policy).

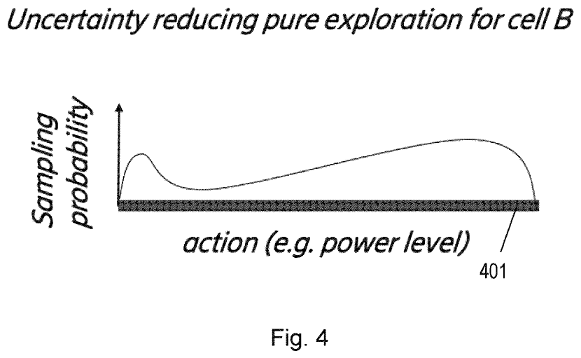

As an example, with reference to the scenario in FIG. 2, Cell B can be labelled as a pure exploration cell, and the process 110 can perform pure exploration in Cell B, while still enforcing the safety criteria of cell B. FIG. 4 is an illustration of a pure exploration policy with safety constraints. A pure exploration policy will sample actions uniformly from the area 401 (which can also be seen in the Cell B safety model in FIG. 3). More elaborate strategies can be designed by considering actions that would minimise the uncertainty of the joint performance model 108. Stochastic policies can be set that will sample actions with a probability proportional to σ_{J}=σ_{A} in this example, as shown in FIG. 4.

Step (v)—In this step the agents 104 perform exploratory actions in the cells 103 based on the exploration policies. In this step, the exploration policies generated by the exploration management function 106 are sent to the agents 104. The agents 104 follow the respective exploration policy until they receive a new one. It is possible that an agent 104 takes multiple exploratory actions using the exploration policy before another one is sent.

In an alternative approach, rather than send the exploration policies to the agents 104, the exploration management function 106 may use the policies to determine an appropriate exploratory action for each agent 104 to perform, and the exploration management function 106 sends information about the relevant exploratory action to the agents 104 instead. Thus, the exploration management function 106 can select/determine joint actions instead of policies. With this approach, the agents 104 should communicate their observations with the exploration management function 106 at each decision step. An advantage of this approach is that the joint safe exploration exploitation process 110 can be determined that has theoretical guarantees on the regret of the system (i.e. how many sub-optimal actions are taken across the whole network).

Step (vi)—In this step, the performance and safety models 108, 110 are updated. After performing the exploratory actions and observing the effect on the cell/network, the agents 104 send their data to a server or the model training function 112. This data can be sent regularly, periodically, on demand, or when a certain amount of data has been collected. The server can forward this data to the model training function 112. When the model training function 112 receives new data, the machine learning model in the RL agent representing the state-action value estimate can be updated (using e.g. Q-learning). The safety models can be updated as well.

The data sent by the agents 104 can take the form of experience tuples, e.g. (o, a, r, o′), which can consist of a sequence of observation, action and reward. The reward is analogous to a performance metric that the agent 104 is trying to optimise and is defined when the agent 104 is deployed.

Any type of machine learning model can be used to represent the models 108, 110. Good candidates of models that also have uncertainty bounds are Gaussian processes or Bayesian neural networks. It is also possible to have separate models for Q, S, σ_{Q}, σ_{S} which can be trained using distributional Q-learning. In the simplest case, they can be tabular models, using counts to estimate the uncertainty of each value (if observations and actions are discrete).

Step (vii)—In this step the exploration management function 106 obtains the new updated model(s) 108, 110 and restarts the procedure of computing the new policies (e.g. from Step (iii) or (iv)). It will be appreciated that the network operator may change the configuration information 116, or the configuration information 116 may otherwise change, between repetitions of step (iv), and step (iv) should use the latest available configuration information 116.

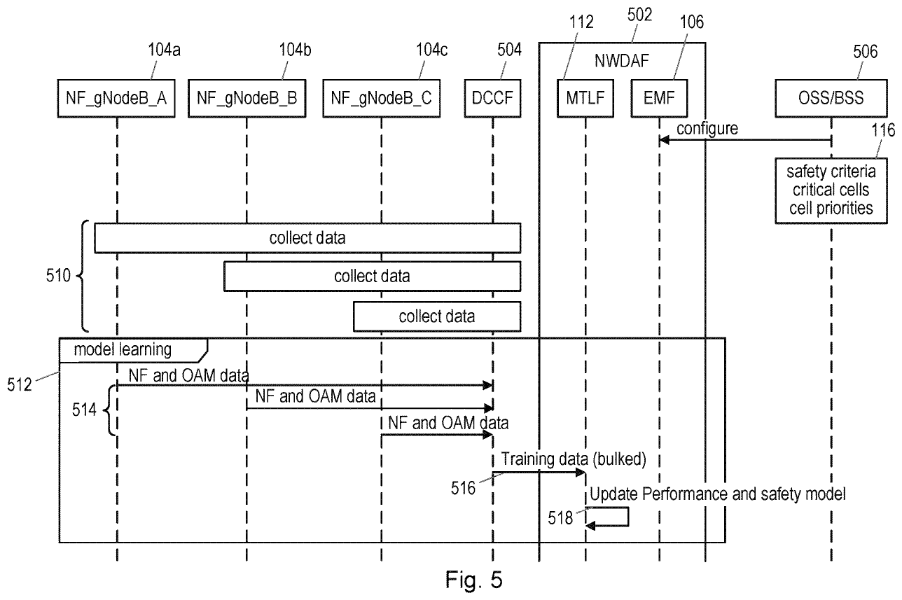

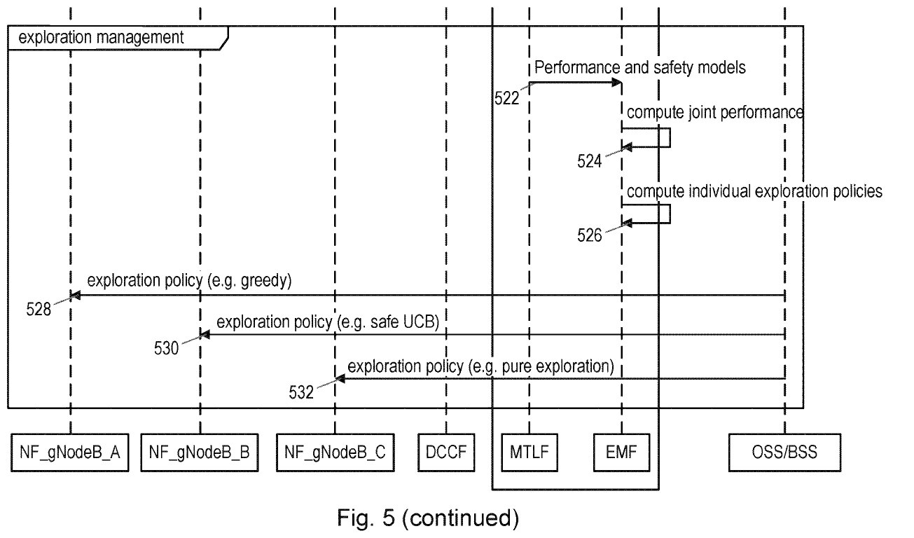

FIG. 5 is a signalling diagram illustrating use of an exploration management function 106 as described above in a 3GPP network. FIG. 5 shows three agents 104 that are deployed in respective cells A, B and C. So that they can be easily distinguished from each other, the agents are respectively labelled 104a, 104b, and 104c. Broadly, cells A, B and C are as shown in FIG. 2. Each agent 104 can be implemented as a network function (NF) in the gNodeB (gNB) 102 that provides the respective cell 103.

The exploration management function 106 and model training function (in the form of a Model Training Logical Function (MTLF)) 112 are part of a Network Data Analytics Function (NWDAF) 502, which is a node in the 5G core (5GC). The exploration management function 106 can be implemented as a new component of the NWDAF 602, which requests models from the MTLF 112 and publishes exploration policies associated to cell identities (IDs). The network function associated with each agent 104 can request their exploration policies by subscribing to the exploration management function 106 part of the NWDAF 106.

The 5GC also comprises a Data Collection Coordination Function (DCCF) 504 that is responsible for collecting/receiving data from the network and passing this to the NWDAF 502 for analysis.

FIG. 5 also includes an Operations Support System (OSS)/Business Support System (BSS) 506. The OSS/BSS 506 is used by the network operator to input the configuration information 116 (such as safety criteria, critical cells and cell priorities) to the exploration management function 106. This generally corresponds to Step (i) described above.

In step 510, the DCCF 604 collects data/information about the network from the cells 103. This information can be obtained by and collected from the agents 104, and/or obtained by and collected from base stations (gNBs) 102. In this step, the agents 104 can send their data to the NWDAF 602 through a NF data collection procedure via the DCCF 504. In cases where the agent 104 is accessing management-related KPIs (e.g. cell configuration), then an operations and Maintenance (OAM) data collection procedure can be used as well.

Block 512 represents the model learning process performed by the model training function (MTLF) 112 to train or retrain the joint performance model 108 and/or joint safe exploration-exploitation process 110. In step 514 data from Cells A, B and C is collected by the DCCF 504. This data can be NF and/or OAM data. The DCCF 504 collects the received data into a training data set and sends this (signal 516) to the MTLF 112 in the NWDAF 502.

In step 518, the MTLF 112 updates the joint performance model 108 and/or the joint safe exploration-exploitation process 110 using the received training data.

The MTLF 112 provides the trained joint performance model 108 and joint safe exploration-exploitation process 110 to the exploration management function 106 (shown by signal 522). This generally corresponds to Step (ii) described above.

The exploration management function 106 computes the joint performance (step 524). This step generally corresponds to Step (iii) described above.

In step 526 the exploration management function 106 computes the respective exploration policies. This generally corresponds to Step (iv) described above.

Signals 528, 530 and 532 represent the determined exploration policies being deployed to cells A, B and C respectively. In this example, the exploration policy for cell A is a greedy policy, the exploration policy for cell B is a safe UCB policy, and the exploration policy for cell C is a pure exploration policy.

The agents 104a-c then perform exploratory actions in their respective cells according to the received exploration policies.

Various extensions to the above techniques can be considered.

One extension relates to considering the effect of neighbouring cells. In particular, to consider the effect of neighbouring cells, neighbouring cells-related KPI can be included when evaluating the performance of a cell.

Another extension relates to applying exploratory actions only for certain users (UEs). That is, in some embodiments, the agent 104 may be able to control a cell parameter that is applied per user or per group of users instead of globally for the whole cell. In this case, the exploration policy of an agent 104 could be configured per user/user group rather than globally for the whole cell. Similarly to how criticality levels are enforced for the cell, criticality levels for the users can be enforced based on their request quality of service (QoS) or type of subscription(s). An example of such parameter is connected mode discontinuous reception (DRX) configuration which can help trade-off higher delay and higher energy consumption.

Another extension addresses privacy issues with data sharing across cells. In addition to functional concerns playing a role when determining a cell's exploration policy, privacy regulations can also have an effect. Two approaches are considered to address the challenge of privacy when it comes to sharing data between cells for exploration management.

In the first approach, data sharing is optional according to possible regulations. The cells that cannot share data with other cells simply do not benefit from the collaborative learning approach for determining the exploration policies set out in this disclosure. If the cells are able to share a limited subset of the data, then they may be able to partly benefit from the collaborative learning approach. Cells could, for example, be labelled as “open/closed for exploration” or “open/closed for policy updates” to ensure that possible restrictions can be considered. Cells could be labelled according to their geographical area. Additionally or alternatively, the type of data might be restricted to a subset of features or statistical insights that are open for sharing due to regulations, and/or deemed most profitable (beneficial/useful) for training. This could also increase the energy efficiency of the system since it reduces data transmission.

The second approach to address privacy concerns makes use of mechanisms that allow data to be securely combined before being shared to the model training function or the exploration management function. That is, to provide data privacy between cells, a data combining node can be introduced into the architecture shown in FIG. 1 in between the agents 104 and the model training function 112.

For data combination, the first step is for the agents 104 (labelled 1 . . . . N) to randomly choose a pair and negotiate a random mask. The training can then proceed by learning the most frequent or majority tuples of <s, a, s′, r> instead of learning individual cases. The learning of the majority tuples hides the identity of the agent 104 (or cell 103) but still allows the exploration management function 106 to learn from that cell 103. An example of the majority tuples is shown in Table 1 below:

TABLE 1

| | Agent 1 (+r1) | Agent 2 (−r1) | Agent N (−rn) | |
|---|---|---|---|---|
| <s, a, s′, r> | F1 + r1 | F2 − r | FN − rn | F1 + F2 + FN |

In this data combination setup it is assumed that the agents 104 do not trust the data combining node or the training infrastructure (e.g. model training function 112). Instead, each agent 104 selects another agent 104 randomly to become their pair. For example Agent 1 chooses Agent 2 and the two negotiate a random number r. Then each agent 104 reports what they experience in an aggregated (combined) manner. For example Agent 1 experienced state s, action a with a new state of s′ and a reward F1+r1 times, while Agent 2 experienced it F2−r2 times. Since the aggregation agents only aggregate, they do not get to know which agent 104 experienced what the most, but only an aggregate/combination of their experiences, which can still be used by the model training function 112 to build the corresponding models 108, 110 for the agents 104. More generally, this technique combines/aggregates the data from the multiple agents, with the contribution from each agent cancelling out the contribution from the other agent, thus concealing the specifics of each contribution.

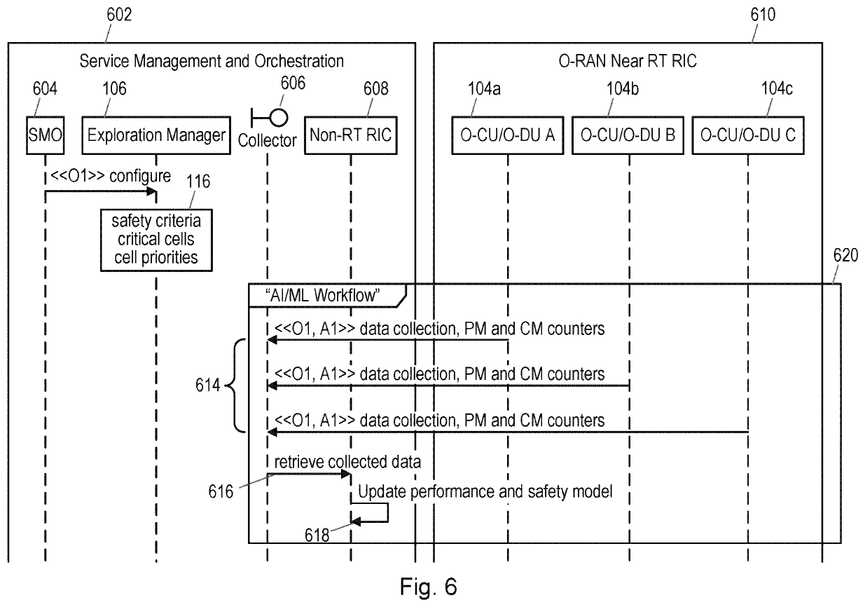

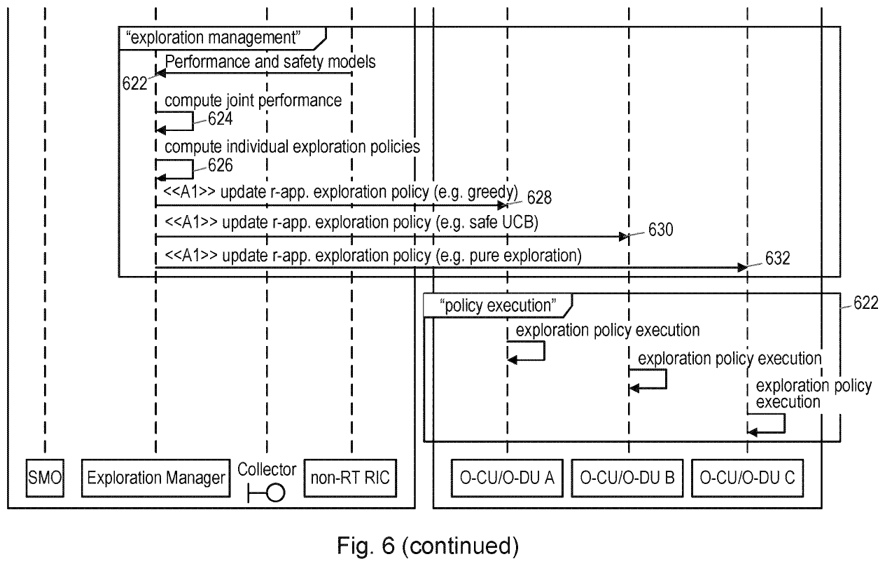

While FIG. 5 illustrates the implementation of the techniques described herein in a 3GPP 5G cellular communication network, it will be appreciated that the techniques can be deployed in other types of network. FIG. 6 is a signalling diagram illustrating the implementation of the techniques described herein in an Open-Radio Access Network (O-RAN) architecture. In FIG. 6, components, steps and signalling that are common to FIG. 5 are given the same reference numerals.

In the O-RAN architecture shown in FIG. 6, the exploration management function 106 is part of the Service Management and Orchestration 602. The exploration management function 106 receives the configuration information 116 from another function in the SMO 604 through the O1 interface.

The SMO 602 comprises a collector 606 that is responsible for data collection (similar to the DCCF 504 in the 5GC. The SMO also comprises a non-real time (non-RT) RAN Intelligent Controller (RIC) 608.

FIG. 6 also includes an O-RAN near-real time (near-RT) RIC 610. The agents 104a-104c are implemented in O-RAN centralised unit (O-CU) and/or O-RAN distributed unit (O-DU).

The training of the performance and safety model is carried out as shown in the O-RAN AI/ML workflow block 620, which is analogous to the model learning block 512 in FIG. 5. The model training by the non-RT RIC 608 can be as illustrated in the O-RAN Alliance: “O-RAN Working Group 1 Use Cases Analysis Report” v 9.00, Section 3.4.3.1. This uses the O1 interface to collect data from the different base stations/agents 104.

The exploration management function 106 retrieves the trained performance and safety models 108, 110 from the non-RT RIC 608. The exploration management function 106 computes the appropriate exploration policy for each cell 103 in a same/similar way to that shown in FIG. 5 and described above. The exploration management function 106 communicates the exploration policies to the near-RT RIC 610 as an r-app to be executed at their respective base stations.

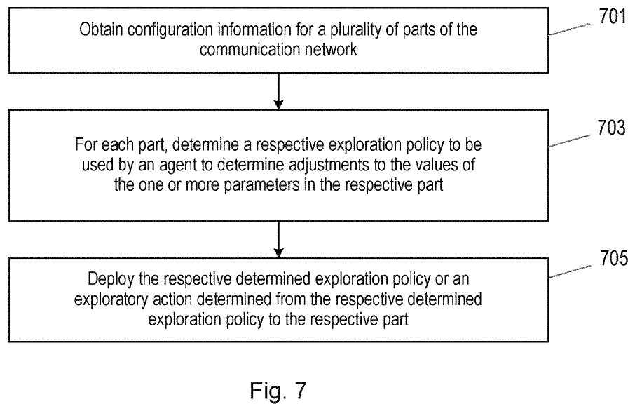

FIG. 7 is a flow chart illustrating a computer implemented method of managing operations of a plurality of agents, e.g. RL agents. Each agent is for adjusting values of one or more parameters in a respective network part of a communication network. The communication network may be a cellular communication network and a network part is a cell. A cell can be any of a macro cell, a micro cell, a femto cell, and a pico cell. In alternative embodiments, the communication network is a computer network or cloud computer network, and each network part is a cluster comprising one or more computing devices.

The method can be performed by an exploration management function 106, or other suitable network node, or other suitable computer or server. The method may be performed in response to executing suitably formulated computer readable code. The computer readable code may be embodied or stored on a computer readable medium, such as a memory chip, optical disc, or other storage medium. The computer readable medium may be part of a computer program product.

In step 701 configuration information is obtained for the plurality of network parts. In some embodiments, the configuration information provides an indication of a type and/or extent of exploratory actions permitted for different network parts by the agent.

The configuration information can comprise, for each network part, any one or more of safety criteria indicating whether or not exploratory actions can be performed with respect to the network part; safety criteria indicating an amount by which a value of the one or more parameters for the network part can be modified when performing an exploratory action; safety criteria indicating an amount by which a performance of the network part can be affected by modifying the value of the one or more parameters when performing an exploratory action; a time window in which safety criteria are applicable or not applicable; a performance metric representing an aggregate of a performance of a plurality or all of the network parts; a privacy criteria indicating whether a network part or an agent for the network part can share data or a model for the network part; a criticality level indicating a type and/or amount of exploratory actions permitted for the network part; and a priority level indicating a priority with which the performance of the network part should be addressed.

In step 703, for each part of the plurality of network parts, a respective exploration policy is determined that is to be used by an agent to determine adjustments to the values of the one or more parameters in the respective network part. The exploration policy is determined based on the received configuration information for the plurality of network parts. The exploration policy is used by an agent or the node or function performing the method to determine one or more exploratory actions to perform for the respective network part. Typically, different exploration policies are determined for different agents/different network parts. In some embodiments, the parameter to be adjusted will affect the whole network part. Alternatively, the parameter to be adjusted will affect one or more users (i.e. not all users) in the network part.

In some embodiments, the exploration policy can indicate an amount and/or range of exploratory actions to be performed for the respective network part. An exploratory action by an agent can comprise the agent adjusting a value of one or more cell parameters to a value determined to be sub-optimal for the network part. The exploratory action may further comprise the agent monitoring the network part to determine an effect of the sub-optimal value of the parameter on the performance of the network part.

The exploration policies for the plurality of network parts can be determined in step 703 to improve or maximise a joint performance measurement metric relating to two or more of the plurality of network parts. The two or more of the plurality of network parts that the joint performance measurement metric relates to can be network parts having a high criticality level (e.g. having a high traffic load).

In step 705, the respective determined exploration policy (or an exploratory action determined from the respective determined exploration policy) is deployed to the respective network part. The exploration policy can then be used by an agent for that network part to determine an exploratory action to perform. If an exploratory action is deployed, the agent for that network part can perform that exploratory action.

In some embodiments, the exploration policy determined in step 703 for a particular network part is one of: a greedy exploration policy; a safe Bayesian optimisation policy, an UCB-based exploration policy; an exploration policy indicating that no exploration by the agent is permitted for the cell; a pure exploration policy; and a balanced exploration policy.

In some embodiments, the agents deployed for each network part are the same. In alternative embodiments, each agent is adapted to the network part for which they are deployed.

In some embodiments of step 703, the exploration policy can be determined to be a greedy exploration policy or another policy that does not allow exploratory actions if the respective network part has a high criticality level (e.g. the traffic volume in that network part is high). In these embodiments, the exploration policy can be determined to be a policy that allows exploratory actions, or that allows all exploratory actions, if the network part has a low criticality level (e.g. the traffic volume in that network part is low).

In some embodiments, the method can further comprise the step of requesting the agent from a model training function 112. The agent can be received from the model training function 112. These steps can be performed before or after either of steps 701 and 703.

In some embodiments, the method can further comprise receiving one or more performance models and/or one or more safety models from a model training function 112. A performance model relates observed performance measurements of a network part to exploratory actions that can be taken in the network part. A safety model relates observed performance measurements for a network part and exploratory actions that can be performed in the network part to a safety measure. One or both of these models is used in step 703 to determine the exploration policies. The performance model and/or the safety model can be machine learning models.

In some embodiments, the method in FIG. 7 is part of a wider method for operating a network performance improvement system. This system comprises an exploration management function 106 that performs the method described above. The system also comprises a plurality of agents 104 and a model training function 112. In the method, the model training function 112 can receive outputs from the plurality of agents 104. These outputs represent the performance of a network part following an adjustment of values of one or more parameters in the network part. The specific form of the output can depend on the parameter that was adjusted. The model training function 112 then trains one or more ML models based on the outputs received from the plurality of agents, and provides the trained ML models to the exploration management function 106 for use in determining the exploration policies in step 703.

In some embodiments, the network performance improvement system also comprises a data combining function. The model training function 112 receives the outputs from the plurality of agents 104 via the data combining function. The data combining function receives a respective combined output representing the cell performance for two or more network parts in the plurality of network parts from the respective agents. The data combining function provides the combined outputs to the model training function 112.

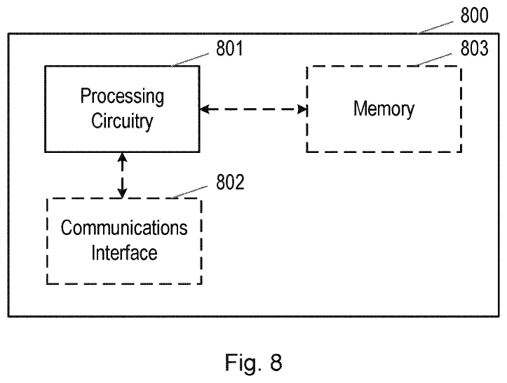

FIG. 8 is a simplified block diagram of an exploration management function 800 according to some embodiments that can be used to implement one or more of the techniques described herein.

The exploration management function 800 comprises processing circuitry (or logic) 801. It will be appreciated that the exploration management function 800 may comprise one or more virtual machines running different software and/or processes. The exploration management function 800 may therefore comprise, or be implemented in or as one or more servers, switches and/or storage devices and/or may comprise cloud computing infrastructure that runs the software and/or processes.

The processing circuitry 801 controls the operation of the exploration management function 800 to implement the relevant part of the methods described herein. The processing circuitry 801 can comprise one or more processors, processing units, multi-core processors or modules that are configured or programmed to control the exploration management function 800 in the manner described herein. In particular implementations, the processing circuitry 801 can comprise a plurality of software and/or hardware modules that are each configured to perform, or are for performing, individual or multiple steps of the method described herein in relation to the exploration management function 800.

The exploration management function 800 also comprises a communications interface 802. The communications interface 802 is for use in enabling communications with other network node, computers, servers, etc. For example, the communications interface 802 can be configured to transmit to and/or receive from other nodes, including the model training function 112 and/or the agents 104, requests, acknowledgements, information, data, signals, or similar. The communications interface 802 can use any suitable communication technology.

The processing circuitry 801 may be configured to control the communications interface 802 to transmit to and/or receive from other nodes, etc. requests, acknowledgements, information, data, signals, or similar, according to the methods described herein.

The exploration management function 800 may comprise a memory 803. In some embodiments, the memory 803 can be configured to store program code that can be executed by the processing circuitry 801 to perform the methods described herein in relation to the exploration management function 800. Alternatively or in addition, the memory 803 can be configured to store any requests, acknowledgements, information, data, signals, or similar that are described herein. The processing circuitry 801 may be configured to control the memory 803 to store such information therein.

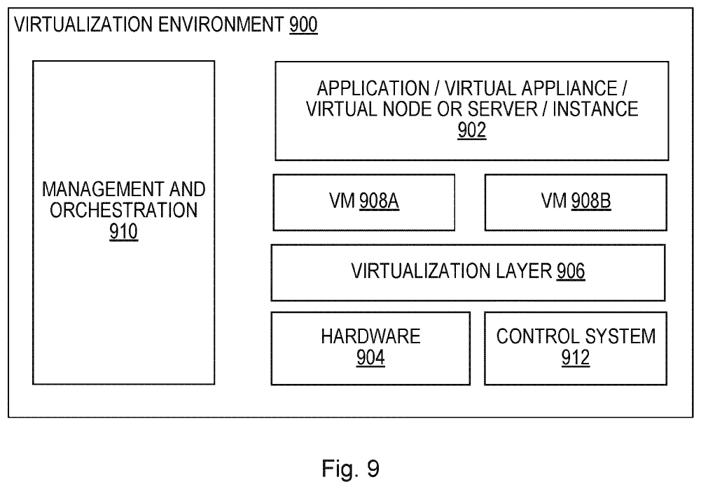

FIG. 9 is a block diagram illustrating a virtualization environment 900 in which functions implemented by some embodiments may be virtualized. For example, the virtualization environment 900 can be used to implement part or all of the functions of the exploration management function 106 and/or the model training function 112 described herein.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 900 hosted by one or more of hardware nodes, such as a hardware computing device that operates as an exploration management function 106, or model training function 112 as described herein. In some embodiments, the node may be entirely virtualized.

Applications 902 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 906 (also referred to as hypervisors or virtual machine monitors (VMMs)), provide VMs 908a and 908b (one or more of which may be generally referred to as VMs 908), and/or perform any of the functions, features and/or benefits described in relation with some embodiments described herein. The virtualization layer 906 may present a virtual operating platform that appears like networking hardware to the VMs 908.

The VMs 908 comprise virtual processing, virtual memory, virtual networking or interface and virtual storage, and may be run by a corresponding virtualization layer 906. Different embodiments of the instance of a virtual appliance 902 may be implemented on one or more of VMs 908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 908 may be a software implementation of a physical machine that runs programs as if they were executing on a physical, non-virtualized machine. Each of the VMs 908, and that part of hardware 904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 908 on top of the hardware 904 and corresponds to the application 902.

Hardware 904 may be implemented in a standalone network node with generic or specific components. Hardware 904 may implement some functions via virtualization. Alternatively, hardware 904 may be part of a larger cluster of hardware (e.g. such as in a data center or CPE) where many hardware nodes work together and are managed via management and orchestration 910, which, among others, oversees lifecycle management of applications 902. In some embodiments, hardware 904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 912 which may alternatively be used for communication between hardware nodes and radio units.

Although the computing devices described herein (e.g. the exploration management function 106) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A computer-implemented method of managing operations of a plurality of agents, wherein each agent is for adjusting values of one or more parameters in a respective network part of the communication network, the method comprising:
obtaining configuration information for the plurality of network parts;
for each part of the plurality of network parts, determining a respective exploration policy to be used by an agent to determine adjustments to the values of the one or more parameters in the respective network part, wherein the exploration policy is determined based on the received configuration information for the plurality of network parts; and
deploying the respective determined exploration policy or an exploratory action determined from the respective determined exploration policy to the respective network part;
wherein the respective determined exploration policy is used to determine one or more exploratory actions to perform for the respective network part.

2. (canceled)

3. The method of claim 1, wherein the exploration policy indicates an amount and/or range of exploratory actions to be performed for the respective network part.

4. The method of claim 2, wherein an exploratory action by an agent comprises the agent:
adjusting a value of one or more parameters to a value determined to be sub-optimal for the network part; and
monitoring the network part to determine an effect of the sub-optimal value of the parameter on the performance of the network part.

5. (canceled)

6. The method of claim 1, wherein the received configuration information provides an indication of a type and/or extent of exploratory actions permitted for different network parts by the agent.

7. The method of claim 1, wherein the exploration policy to be used for the respective network part is determined as one of: a greedy exploration policy; a safe Bayesian optimisation policy, an upper confidence bound, UCB, based exploration policy; an exploration policy indicating that no exploration by the agent is permitted for the network part; a pure exploration policy; and a balanced exploration policy.

8. The method of claim 1, wherein the exploration policy determined for one or more of the plurality of network parts is different to the exploration policy determined for one or more other network parts in the plurality of network parts.

9. The method of claim 1, wherein the same agent is deployed for each network part.

10. The method of claim 1, wherein the agents are adapted to the network part for which they are deployed.

11. The method of claim 1, wherein the configuration information comprises, for each network part, any one or more of:
safety criteria indicating whether or not exploratory actions can be performed with respect to the network part;
safety criteria indicating an amount by which a value of the one or more parameters for the network part can be modified when performing an exploratory action;
safety criteria indicating an amount by which a performance of the network part can be affected by modifying the value of the one or more parameters when performing an exploratory action;
a time window in which safety criteria are applicable or not applicable;
a performance metric representing an aggregate of a performance of a plurality or all of the network parts;
a privacy criteria indicating whether a network part or an agent for the network part can share data or a model for the network part;
a criticality level indicating a type and/or amount of exploratory actions permitted for the network part; and
a priority level indicating a priority with which the performance of the network part should be addressed.

12. The method of claim 11, wherein the step of determining comprises any of:
for a network part that has a high criticality level, determining the exploration policy as a greedy exploration policy or determining the exploration policy as a policy that does not allow exploratory actions; and
for a network part that has a low criticality level, determining the exploration policy as a policy that allows exploratory actions, or that allows all exploratory actions.

13. The method of claim 1, wherein the method further comprises:
requesting the agent from a model training function.

14. The method of claim 1, wherein the method further comprises:
receiving the agent from a model training function.

15. The method of claim 1, further comprising:
receiving one or more performance models and/or one or more safety models from a model training function, wherein a performance model relates observed performance measurements of a network part to exploratory actions that can be taken in the network part, and a safety model relates observed performance measurements for a network part and exploratory actions that can be performed in the network part to a safety measure;
wherein the step of determining comprises using the received one or more performance models and/or one or more safety models to determine the exploration policies; and
wherein the performance model and/or the safety model are machine learning models.

16. (canceled)

17. The method of claim 1, wherein the step of determining comprises determining the exploration policies for the plurality of network parts to improve or maximise a joint performance measurement metric relating to two or more of the plurality of network parts.

18. The method of claim 17, wherein the two or more of the plurality of network parts that the joint performance measurement metric relates to are network parts having a high criticality level.

19. The method of claim 1, wherein adjusting the parameter affects the whole network part, or one or more users in the network part.

20-22. (canceled)

23. A method of operating a network performance improvement system, the network performance improvement system comprising a plurality of agents, an exploration management function and a model training function, the method comprising:
the exploration management function performing the method of claim 1;
the model training function:
(i) receiving outputs from the plurality of agents representing network part performance following an adjustment of values of one or more parameters in a respective network part of the communication network;
(ii) training, based on the outputs received from the plurality of agents, one or more machine learning, ML, models used by the exploration management function to determine the exploration policies; and
(iii) providing the trained ML models to the exploration management function for use in determining the exploration policies.

24. The method of claim 1, wherein the communication network is a cellular communication network and a network part (103) is a cell, wherein the network performance improvement system further comprises a data combining function, and the model training function receives the outputs from the plurality of agents via the data combining function, and wherein the method further comprises:
the data combining function receiving, from a plurality of agents, a respective combined output representing the performance for two or more network parts in the plurality of network parts; and
the data combining function providing, to the model training function, the combined outputs.

25. A computer program comprising computer readable code configured such that, on execution by a suitable computer or processor, the computer or processor is caused to perform the method according to claim 1.

26-27. (canceled)

28. An exploration management function comprising a processor and a memory, said memory containing instructions executable by said processor whereby said exploration management function is operative to perform the method of claim 1.
